(19) United States
(12) Patent Application Publication
(10) Pub. No.: US 2019/0027011 A1
(43) Pub. Date: Jan. 24, 2019

(54) Child Safety Seat And Temperature Warning System

(71) Applicant: Jeanne Gordon, Athol, ID (US)

(72) Inventor: Jeanne Gordon, Athol, ID (US)

(21) Appl. No.: 16/139,906

(22) Filed: Sep. 24, 2018

Related U.S. Application Data
(63) Continuation-in-part of application No. 14/736,546, filed on Jun. 11, 2015, now abandoned.

(51) Int. Cl. G08B 21/02; B60N 2/00; B60N 2/28; B60Q 9/00; G08B 21/04; G08B 21/22

(52) U.S. Cl. CPC G08B 21/0225; B60N 2/002; G08B 21/22; B60Q 9/00; G08B 21/0461; B60N 2/28

(57) ABSTRACT

A child safety seat and temperature warning system includes a child restraint including a seat and a backrest that is attached to and extends upwardly from the seat. A processor is mounted in the child restraint. A weight sensor is mounted within the seat and detects when a weight is positioned on the seat. A heat sensor is mounted in the child restraint and detects an ambient temperature adjacent to the child restraint. The weight sensor and the heat sensor are electrically coupled to the processor. A vehicle includes an alarm system that is in communication with the processor. The vehicle alarm system is turned on when the vehicle alarm system receives a warning signal. The warning signal is sent by the heat sensor to the processor when the weight sensor detects a weight and the heat sensor detects an unsuitable temperature which is greater than an upper threshold temperature.

### REFERENCE TO RELATED APPLICATIONS

This application is a continuation in part of Ser. No. 14/736,546 filed Jun. 11, 2015.

### BACKGROUND OF THE DISCLOSURE

### Field of the Disclosure

The disclosure relates to vehicle temperature warning systems and more particularly pertains to a new vehicle temperature warning system for preventing injury to a child from exposure to heat or cold within a vehicle.

### SUMMARY OF THE DISCLOSURE

An embodiment of the disclosure meets the needs presented above by generally comprising a child restraint including a seat and a backrest is attached to and extends upwardly from the seat. A processor is mounted in the child restraint. A weight sensor is mounted within the seat and detects when a weight is positioned on the seat. A heat sensor is mounted in the child restraint and detects an ambient temperature adjacent to the child restraint. The weight sensor and the heat sensor are electrically coupled to the processor. A vehicle includes an alarm system and the processor is in communication with the alarm system. The vehicle alarm system emits sound and flashing light when the vehicle alarm system receives a warning signal. The warning signal is sent by the heat sensor to the processor when the weight sensor detects a weight and the heat sensor detects an unsuitable temperature which is greater than an upper threshold temperature.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a child safety seat and temperature warning system according to an embodiment of the disclosure.

FIG. 2 is a front perspective view of a vehicle console of an embodiment of the disclosure.

FIG. 3 is a side view of an embodiment of the disclosure.

FIG. 4 is a schematic view of an embodiment of the disclosure.

FIG. 5 is a perspective in-use view of an embodiment of the disclosure.

### DESCRIPTION OF THE PREFERRED EMBODIMENT

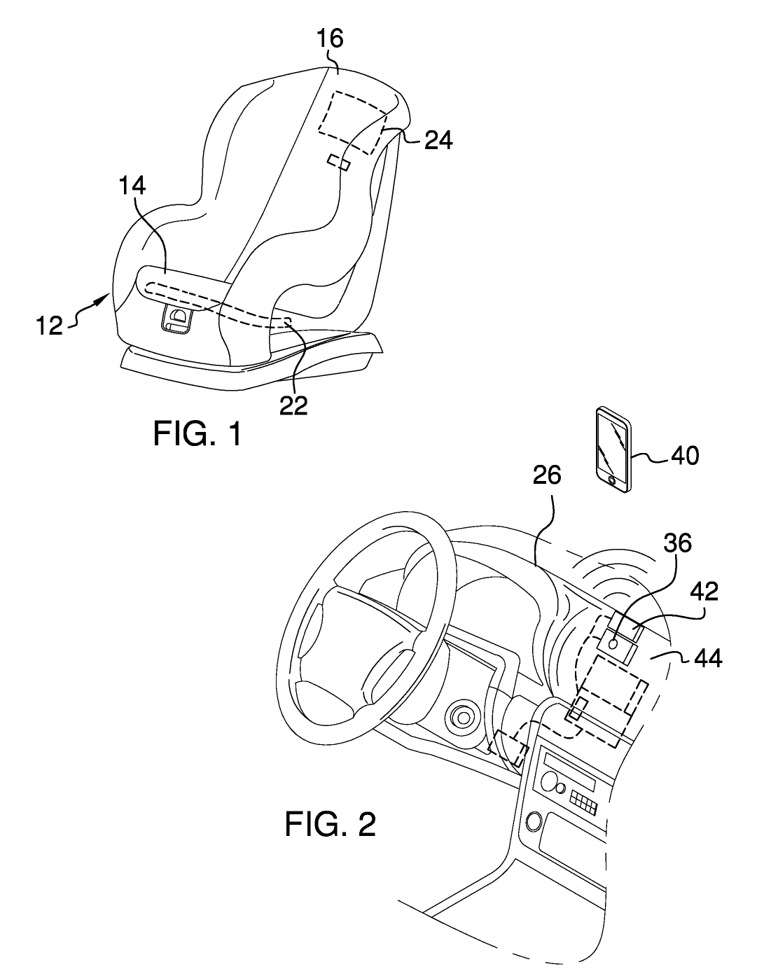

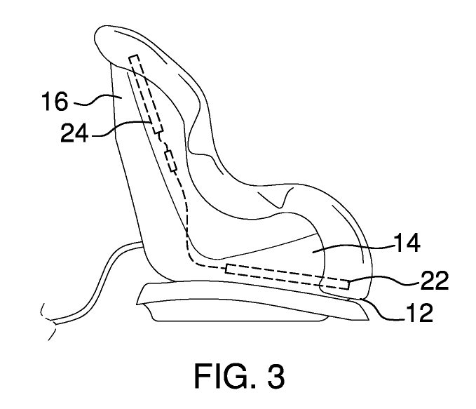

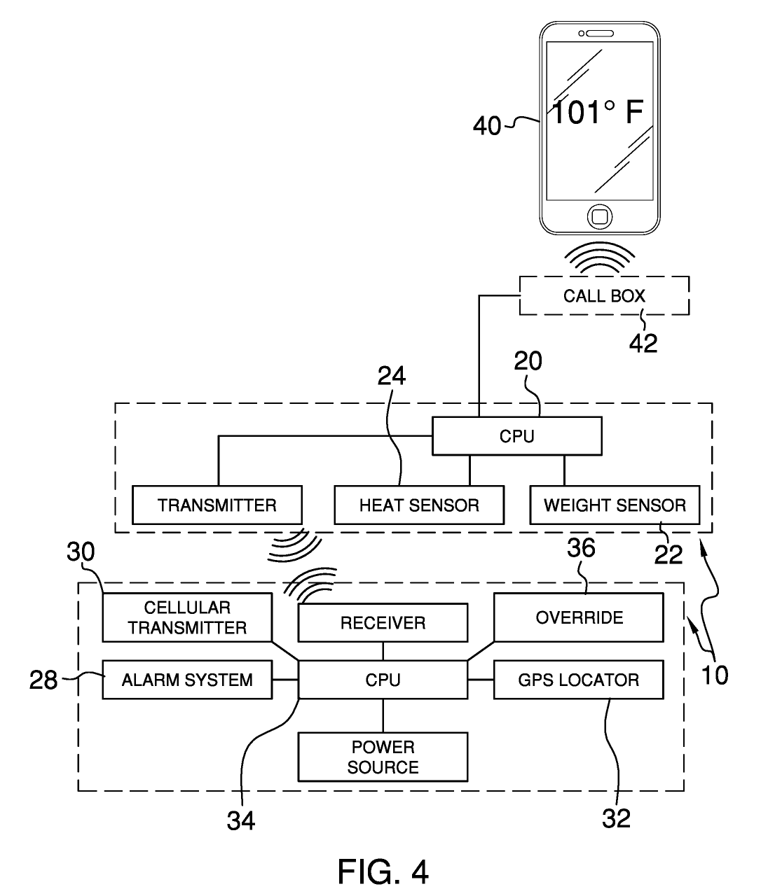

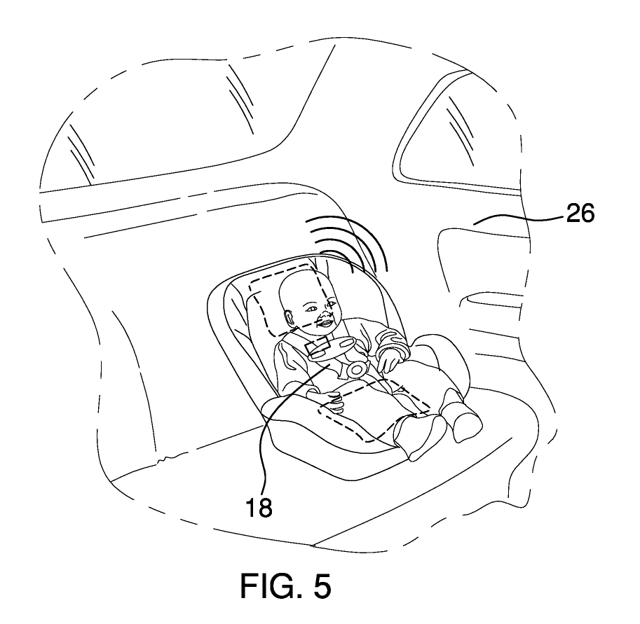

With reference now to the drawings, and in particular to FIGS. 1 through 5 thereof, a new vehicle temperature warning system embodying the principles and concepts of an embodiment of the disclosure and generally designated by the reference numeral 10 will be described.

As best illustrated in FIGS. 1 through 5, the child safety seat and temperature warning system 10 generally comprises a child restraint 12 including a seat 14 and a backrest 16 that is attached to and extends upwardly from the seat 14. The child restraint 12 is generally a conventional child vehicle safety seat including straps 18 for restraining a child on the seat 14.

A processor 20, or CPU, is mounted in the child restraint 12 and a weight sensor 22 is mounted within the seat 14 to detect when a weight is positioned on the seat 14. The weight sensor 22 may be set such that it is only actuated when a load above a minimum weight, such as 5.0 lbs., is detected. A heat sensor 24 is mounted in the child restraint 12 and detects an ambient temperature adjacent to the child restraint 12. The weight sensor 22 and the heat sensor 24 are each electrically coupled to the processor 20 and the heat sensor 24 may be in a normally off position until the weight sensor 22 detects weight upon the seat 14. A power supply, such as a battery, may be mounted in the seat 14 or backrest 16 and be electrically coupled to the processor 20. Alternatively, the power supply may be a battery of a vehicle 26.

The vehicle 26 includes a generally conventional alarm system 28 which will utilize a horn of the vehicle or other sound emitter to emit sound and will also utilize the vehicle lights which can be flashed on and off when the alarm system is tripped. The processor 20 is in communication with the alarm system 28. This communication may be by direct hardwiring or by wireless communication. The alarm system 28 includes a transmitter 30 configured to transmit a cellular emergency signal. A global positioning system 32 provides a location to the transmitter 30 such that the location is transmitted by the transmitter 30. The vehicle alarm system 28 emits sound and flashes lights when the vehicle alarm system 28 receives a warning signal. The warning signal is sent by the heat sensor 24 to the processor 20 when the weight sensor 22 detects a weight and the heat sensor 24 detects an unsuitable temperature that is greater than an upper threshold temperature or less than a lower threshold temperature. The upper threshold temperature may be approximately 90° F. and the lower threshold temperature may be approximately 50° F.

The alarm system 28 includes a timer for measuring a time elapsed of the alarm system 28 continuously receiving the warning signal. The timer, which may simply be a program on a control circuit 34, or CPU, coupled to the alarm system 28, may be used to only allow the warning signal to trigger the alarm system 28 after a predetermined time of between 1.0 minutes and 5.0 minutes to allow for the vehicle 26 to be started and the interior temperature thereof to move within a suitable range. More particularly, the transmitter 30 transmits the cellular emergency signal when the time elapsed is greater than a threshold time. Thus, if the child is not removed from the seat 14 or if the temperature is not placed in the suitable range within the threshold time, emergency responders will be summoned using a conventional emergency calling system such a 911 system. An override switch 36 is mounted in the vehicle 26 and is electrically coupled to the alarm system 28. The transmitter 30 transmits the cellular emergency signal when the override switch 36 is actuated. The override switch 36 may include a covering, not shown, to prevent accidental actuation thereof.

The system 10 further incorporates a cellular remote device 40 which may be a conventional cellular phone or smartphone to be carried by the user. A call box 42 is positioned on a dashboard 44 of the vehicle 26. The call box 42 is operationally coupled to the processor 34. The call box 42 is programmable to initiate a telecommunication to the cellular remote device 40. The call box 42 may be programmed through interaction with an app on the cellular remote device 40 or through conventional input mechanisms such as keys or buttons. The telecommunication initiated by the call box 42 includes transmitting a temperature within the vehicle 26 as detected by the heat sensor 24. The cellular remote device 40 displays the temperature within the vehicle 26 as detected by the heat sensor 24 upon the cellular remote device 40 receiving the telecommunication. The cellular remote device 40 is configured to display the temperature within the vehicle 26 as detected by the heat sensor 24 without the telecommunication being responded to by the user. That is, the temperature is displayed prior to and without requiring the user to interact with the cellular remote device 40. The display of the temperature is automatic when the telecommunication is received by the cellular remote device 40. The call box 42 may be distinct from and extrinsic to the vehicle alarm system 28 as described above. The processor 34 activates the call box 42 to initiate the telecommunication a predetermined length of time after the alarm system 28 receives the alarm signal. Thus, an opportunity is provided to allow response to the alarm system 28 before the user is notified through activation of the call box 42.

In use, the restraint device 12 is used in a conventional manner to safely restrain a child within a vehicle 26. However, if a child is on the seat and the temperature within the vehicle 26 becomes such that the child's health is in danger, the system 10 will activate the vehicle's alarm system 28 to attract persons passing near the vehicle 26 to assist in removing the child from the vehicle 26. If the alarm system 28 has been activated for an elongated period of time, such as between 5.0 minutes and 15.0 minutes, the transmitter 30 of the alarm system will contact rescue authorities and provide coordinates to the location of the vehicle 26 using conventional cellular technology.

Similarly, the call box 42 may be activated simultaneous to, before, or after the transmitter 30 is activated to contact rescue authorities.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A child safety seat and temperature warning system, said system comprising:
a child restraint including a seat and a backrest being attached to and extending upwardly from said seat;
a processor being mounted in said child restraint;
a weight sensor being mounted within said seat and detecting when a weight is positioned on said seat;
a heat sensor being mounted in said backrest of said child restraint and detecting an ambient temperature adjacent to said child restraint, said weight sensor and said heat sensor being operationally coupled to said processor;
a vehicle including a dashboard and an alarm system, said processor being in communication with said alarm system;
said vehicle alarm system emitting sound and flashing light when said vehicle alarm system receives a warning signal, said warning signal being sent by said heat sensor to said processor when said weight sensor detects a weight and said heat sensor detects an unsuitable temperature being greater than an upper threshold temperature;
a cellular remote device; and
a call box, said call box being operationally coupled to said processor, said call box being programmable to initiate a telecommunication to said cellular remote device, said telecommunication including transmitting a temperature within said vehicle as detected by said heat sensor, said cellular remote device displaying the temperature within said vehicle as detected by said heat sensor upon said cellular remote device receiving said telecommunication wherein said cellular remote device is configured to display the temperature within said vehicle as detected by said heat sensor without said telecommunication being responded to by a user.

2. The child safety seat and temperature warning system according to claim 1, wherein:
said alarm system includes:
a transmitter configured to transmit a cellular emergency signal;
a global positioning system providing a location to said transmitter such that the location is transmitted by said transmitter.

3. The child safety seat and temperature warning system according to claim 2, wherein said transmitter transmits said cellular emergency signal when said warning signal is received by said alarm system.

4. The child safety seat and temperature warning system according to claim 2, wherein said alarm system including a timer for measuring a time elapsed of said alarm system receiving said warning signal, said transmitter transmitting said cellular emergency signal when said time elapsed is greater than a threshold time.

5. The child safety seat and temperature warning system according to claim 4, further including an override switch being mounted in said vehicle and being electrically coupled to said alarm system, said transmitter transmitting said cellular emergency signal when said override switch is actuated.

6. The child safety seat and temperature warning system according to claim 2, further including an override switch being mounted in said vehicle and being electrically coupled to said alarm system, said transmitter transmitting said cellular emergency signal when said override switch is actuated.

7. The child safety seat and temperature warning system according to claim 1, wherein said warning signal is sent by said heat sensor detects an unsuitable temperature being less than a lower threshold temperature.

8. The child safety seat and temperature warning system according to claim 1, wherein said call box is positioned on said dashboard of said vehicle.

9. The child safety seat and temperature warning system according to claim 2, wherein said call box is distinct from and extrinsic to said vehicle alarm system.

10. The child safety seat and temperature warning system of claim 1, further comprising said processor activating said call box to initiate said telecommunication a predetermined length of time after said alarm system receives said alarm signal.

11. A child safety seat and temperature warning system, said system comprising:
a child restraint including a seat and a backrest being attached to and extending upwardly from said seat;
a processor being mounted in said child restraint;
a weight sensor being mounted within said seat and detecting when a weight is positioned on said seat;
a heat sensor being mounted in said backrest of said child restraint and detecting an ambient temperature adjacent to said child restraint, said weight sensor and said heat sensor being electrically coupled to said processor;
a vehicle including an alarm system, said processor being in communication with said alarm system, said alarm system including:
a transmitter configured to transmit a cellular emergency signal;
a global positioning system providing a location to said transmitter such that the location is transmitted by said transmitter;
said vehicle alarm system emitting sound and flashing light when said vehicle alarm system receives a warning signal, said warning signal being sent by said heat sensor to said processor when said weight sensor detects a weight and said heat sensor detects an unsuitable temperature being greater than an upper threshold temperature or less than a lower threshold temperature;
said alarm system including a timer for measuring a time elapsed of said alarm system receiving said warning signal;
said transmitter transmitting said cellular emergency signal when said time elapsed is greater than a threshold time;
an override switch being mounted in said vehicle and being electrically coupled to said alarm system, said transmitter transmitting said cellular emergency signal when said override switch is actuated;
a cellular remote device; and
a call box, said call box being positioned on said dashboard of said vehicle, said call box being operationally coupled to said processor, said call box being programmable to initiate a telecommunication to said cellular remote device, said telecommunication including transmitting a temperature within said vehicle as detected by said heat sensor, said cellular remote device displaying the temperature within said vehicle as detected by said heat sensor upon said cellular remote device receiving said telecommunication wherein said cellular remote device is configured to display the temperature within said vehicle as detected by said heat sensor without said telecommunication being responded to by a user, said call box being distinct from and extrinsic to said vehicle alarm system, said processor activating said call box to initiate said telecommunication a predetermined length of time after said alarm system receives said alarm signal.
